(19) United States
(12) Patent Application Publication
(10) Pub. No.: US 2005/0077341 A1
(43) Pub. Date: Apr. 14, 2005

(54) Method of manufacturing an active cooling panel out of thermostructural composite material

(75) Inventors: Jean-Michel Larrieu, Macau (FR); Gilles Uhrig, Pyla Sur Mer (FR); Jacques Thebault, Bordeaux (FR); Clement Bouquet, Bordeaux (FR)

Correspondence Address: WEINGARTEN, SCHURGIN, GAGNEBIN & LEBOVICI LLP, TEN POST OFFICE SQUARE, BOSTON, MA, 02109, US

(73) Assignee: Snecma Propulsion Solide

(21) Appl. No.: 10/765,426

(22) Filed: Jan. 27, 2004

(30) Foreign Application Priority Data
Jan. 30, 2003 (FR) 03 01040

(51) Int. Cl. B23K 28/00

(52) U.S. Cl. 228/193; 228/194; 228/254

(57) ABSTRACT

A metal coating is formed on the inside face of a first thermostructural composite material part presenting indentations forming channels, and also on the inside face of a second thermostructural composite material part for being applied against the inside face of the first part, and the first and second parts are assembled together by bonding said inside faces together by hot compression, in particular by hot isostatic pressing, thereby obtaining a thermostructural composite material cooling panel having integrated fluid flow channels. The invention is applicable to making heat exchanger walls such as the walls of combustion chambers in aircraft engines, or the diverging portions of rocket engines, or plasma confinement chambers in nuclear fusion reactors.

### BACKGROUND OF THE INVENTION

The present invention relates to manufacturing an active ooling panel out of thermostructural composite material.

The term “active cooling panel” is used herein to mean a panel having a cooling fluid passing therethrough for the purpose of taking away the heat received by the panel being exposed to high temperature or high heat flux.

The term “thermostructural composite material” is used herein to mean a composite material having mechanical properties which make it suitable for constituting structural elements and having the ability to conserve these mechanical properties at high temperature. Thermostructural composite materials are typically carbon-carbon (C/C) type composite material comprising a reinforcing structure made of carbon fibers densified by a matrix of carbon, and ceramic matrix composite (CMC) materials comprising a reinforcing structure of refractory fibers (in particular carbon fibers or ceramic fibers) densified by a ceramic matrix.

Applications of the invention lie in particular in constituting the walls of a combustion chamber in an aircraft engine, which walls convey a cooling fluid which may be constituted by the fuel that is injected into the chamber, or walls for the diverging portions of rocket engines which are likewise cooled by fluid, which fluid may be a propellant component injected into the combustion chamber of the rocket engine, or indeed the walls of a plasma confinement chamber in a nuclear fusion reactor. In such applications, the panel acts as a heat exchanger between its face that is exposed to high temperature or high heat flux and the fluid it conveys.

In such heat exchanger walls, the use of active cooling panels made of thermostructural composite material enables the operation of systems including such heat exchangers to be extended to higher temperatures and/or enables the lifetime of such systems to be extended. Increasing operating temperature can enable performance to be increased, in particular the efficiency of combustion chambers or nozzles in aviation or space engines, and can also reduce the amount of pollution emitted by aircraft engines.

Making a part out of thermostructural composite material generally requires a porous fiber preform to be prepared of a shape that is close to the shape of the part that is to be made, with the preform then being densified.

Densification can be performed by a liquid technique or by a gas technique. Liquid densification consists in impregnating the preform with a liquid that is a precursor of the matrix material, which precursor is generally a resin, and in transforming the precursor, usually by heat treatment. The gas technique or chemical vapor infiltration (CVI) consists in placing the preform in an enclosure and in admitting a reaction gas into the enclosure, which gas diffuses under determined conditions of pressure and temperature into the pores of the preform and forms a solid deposit therein by one or more of the components of the gas decomposing or reacting together. Both techniques, using a liquid or CVI are well known and they can be combined, for example by performing predensification or consolidation of the preform using a liquid followed by CVI.

Whatever the densification method used, thermostructural composite materials present residual porosity so they are unsuitable for use on their own in forming cooling panels having internal fluid-conveying passages, since the walls of such passages are not leakproof.

Several solutions have been proposed to overcome this difficulty and to enable active cooling by means of a flowing fluid to be combined with the use of porous refractory materials.

A first solution consists in making a panel having a front plate made of graphite on its side that is exposed to high temperatures, and a rear plate made of metal, in particular steel, with the channels for conveying the cooling fluid being made therein. The two plates are assembled together by brazing, with layers of metal being interposed to match the different coefficients of thermal expansion of steel and of graphite. The presence of solid metal is penalizing in terms of the mass of the cooling panel. In addition, the length of the path along which heat travels through the graphite plate and the metal plate puts a limit on capacity to cool the exposed surface.

Another solution consists in forming passages in a block of thermostructural composite material and in making the walls of the passages leakproof by brazing a metal lining, e.g. made of copper.

Yet another solution consists in making two plates out of thermostructural composite material, one of which plates presents channels machined in its face that is to be assembled with a facing face of the other plate, with assembly being performed by brazing.

The second and third solutions are satisfactory in terms of mass and of shortening heat flow path length, but leakage problems can arise due to the metal lining or the brazing cracking following repeated exposure to very high temperatures.

### OBEJECT AND SUMMARY OF THE INVENTION

An object of the invention is to provide a method of manufacturing an active cooling panel out of thermostructural composite material presenting leakproofing that is effective and durable for a fluid flowing in internal passages of the panel.

This object is achieved by a method of the type comprising the steps consisting in providing a first part of thermostructural composite material having an inside face presenting indentations forming channels, forming a metal coating on said face of the first part, providing a second part of thermostructural composite material having an inside face for application on said inside face of the first part, forming a metal coating on said inside face of the second part, and assembling the first and second parts together by bonding said inside faces together, thereby obtaining a cooling panel of thermostructural composite material having integrated fluid flow channels, in which method, according to the invention, the parts are assembled together by bonding said inside faces together by hot compression.

Bonding may be implemented by hot isostatic pressing or by pressing the parts in a hot press.

This kind of bonding presents the advantage of avoiding the use of a liquid as is required for brazing, and the temperature required is lower than that required for brazing. Continuity of the metal coating is thus better preserved.

In an implementation of the method, for the bonding by hot compression, use is made of at least a portion of the metal coatings formed on said inside faces of the first and second parts, the metal coatings serving both to provide sealing and to provide bonding.

In a variant, or in addition, for the bonding by hot compression, a metal foil is interposed between said inside faces of the parts provided with metal coatings in order to guarantee even better sealing beside at least one of the inside faces of the assembled-together parts, where appropriate.

In a particular implementation of the method, the metal coatings are formed by forming first and second superposed deposits, the first deposit having a function of constituting a reaction barrier between the components of the thermostructural composite material and the second deposit, and/or an expansion matching function, and the second deposit contributing to bonding between the parts by hot compression.

The first deposit may be selected from rhenium, molybdenum, tungsten, niobium, and tantalum. When the parts to be assembled together are made of a composite material including silicon, the first deposit is preferably of rhenium.

The metal of the metal layer enabling bonding by hot compression may be selected from nickel, copper, iron, and an alloy of at least one or more thereof. It is preferable to use nickel or a nickel alloy.

Advantageously, the metal coating is formed at least in part by physical vapor deposition, or by plasma sputtering.

In another particular implementation of the method, said inside faces of the parts are provided with metal coatings by hot isostatic pressing using a metal foil.

It is then possible to assemble the first part with a metal foil that has previously been shaped to match the shape of the indentations in the inside face of the first part.

The foil forming the metal coating may be of a metal selected from niobium, molybdenum, tungsten, and tantalum.

According to an advantageous feature of the invention, prior to forming the metal coatings on said inside faces of the parts to be assembled together, treatment is performed to reduce the surface porosity of the thermostructural composite material on at least one of said inside faces.

This reduction in porosity may be achieved by applying a suspension to the surface of at least one of said inside faces of the part, the suspension comprising a ceramic powder and a ceramic material precursor in solution, and by transforming the precursor into ceramic material.

The ceramic material precursor may be a polymer which is cross-linked prior to being transformed into ceramic by heat treatment.

After the ceramic material precursor has been transformed and before the metal coating has been formed, it is possible to deposit ceramic by chemical vapor infiltration or deposition on said inside faces of the parts to be assembled together so as to form a thin and continuous layer of ceramic on the surfaces thereof.

### BRIEF DESCRIPTION OF THE DRAWINGS

The invention will be better understood on reading the description given below by way of non-limiting indication and with reference to the accompanying drawings, in which:

FIG. 1 is a perspective view of two parts for forming an active cooling panel;

FIGS. 2 to 7 are highly diagrammatic section views showing successive steps in an implementation of a method of the invention applied to the parts of FIG. 1; and

FIGS. 8 to 10 are highly diagrammatic section views showing successive steps in another implementation of the method of the invention.

### DETAILED DESCRIPTION OF IMPLEMENTATIONS OF THE INVENTION

A first step of the method consists in providing two parts made of thermostructural composite material, at least one of which has a face in which indentations are formed to constitute channels, so as to build up a cooling panel by assembling the two parts together.

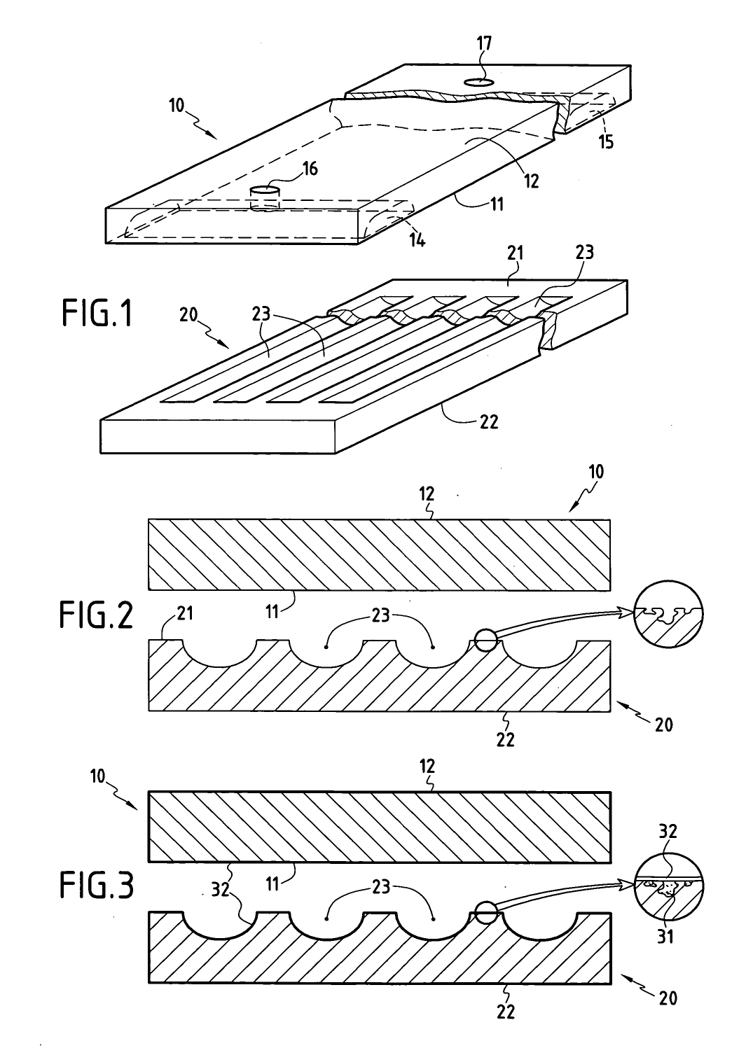

FIG. 1 shows two such parts 10 and 20 in the form of plates. The parts 10 and 20 present inside faces 11, 21 which are to be assembled together, and outside faces 12, 22 that are opposite from their inside faces.

In the example shown, the indentations forming channels 23 of substantially semicircular section are formed in the inside face 21 of the part 20, while the inside face 11 of the part 10 does not have any such indentations.

In a variant, the indentations may be formed in both inside faces 11 and 21, advantageously in zones that are situated in register so as to be able to build up each channel by combining two facing indentations.

When the channels are formed in one part only, it is preferable to form them in the part whose outside face is to be exposed to heat flux when the cooling panel is in use so as to shorten the heat flow path length between said exposed face and a cooling fluid flowing in the channels.

In the example shown, the channels 23 extend over the major fraction of the length of the part 20, opening out at their ends into manifolds formed by indentations 14, 15 formed in the inside face 11 of the part 10. Holes 16, 17 opening out into the manifolds and into the outside surface 12 of the part 10 enable the manifolds to communicate with ducts for feeding or removing cooling fluid, or to communicate via couplings with similar cooling panels that are adjacent. The part 10 may be of greater thickness over the indentations 14, 15 so as to avoid any excessive local reduction in wall thickness.

The manifolds could equally well be formed by combining indentations formed in the inside faces 11 and 21 of both parts 10 and 20.

In a variant, the channels 23 may each have at least one end opening out into an end wall of the part 20. After the cooling panel has been formed, the open ends of the channels can then be connected via couplings either to a manifold located outside the panel or to similar channels in an adjacent panel.

Although only four channels 23 are shown in the drawings, the number of channels may be much greater.

The parts 10 and 20 may generally be in the form of rectangular paralellepipeds or they may be curved, depending on the final shape desired for the cooling panel.

The parts are made of C/C or CMC thermostructural composite material. For very high temperature applications, in particular in an oxidizing medium, the use of CMC is preferred, typically composite materials reinforced by silicon carbide (SiC) fibers or by carbon fibers with an SiC matrix or a matrix in which at least the outer phase is made of SiC. The channels and the manifolds may be formed by machining.

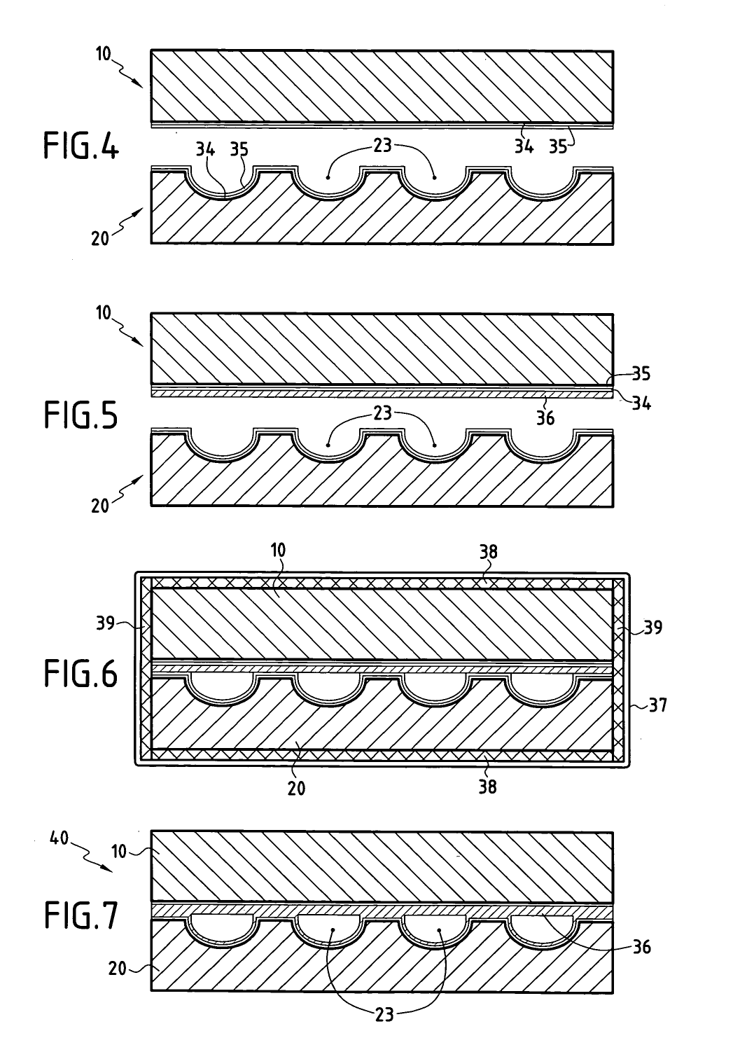

Whatever the thermostructural composite material that is used, it presents residual porosity, in particular surface porosity as shown very diagrammatically in FIG. 2.

Prior to assembling the parts together, it is therefore useful to make the inside faces leakproof.

Before performing such sealing, it is advantageous to reduce the surface porosity of the inside faces of the parts to be assembled together. This reduction of porosity may be performed on one of the inside faces only insofar as the requirement for sealing is less severe for the other inside face. This can apply to an active cooling panel for a combustion chamber wall when the cooling fluid used is fuel and leakage through the combustion chamber side can be tolerated to some extent.

Porosity reduction can comprise applying a suspension to the inside face of one or both parts, which suspension contains a solid filler in the form of a ceramic powder and a ceramic precursor in solution, with the ceramic material precursor then being transformed. The precursor may be a polymer which is cross-linked and then transformed into a ceramic by heat treatment. By way of example, it is possible to use as the precursor a polycarbosilane (PCS) or a polytitanocarbosilane (PTCS) constituting a precursor for SiC, which is put into solution in a solvent, e.g. xylene. The ceramic powder contributes to ensuring that the surface pores are filled effectively. It is possible to use SiC powder, for example.

The liquid composition may be applied using a brush or a spray gun, with the quantity of solvent being selected to make application easy and to encourage the liquid composition to penetrate into the surface pores.

After the liquid composition has been applied and dried by eliminating the solvent, the precursor polymer is cross-linked and then transformed into ceramic. For example when using PCS, cross-linking can be performed by raising the temperature to about 350° C., and ceramization can be performed by raising the temperature to about 900° C.

After ceramization, it is possible to shave the surface of the part in order to restore it to its initial shape.

The detail of FIG. 3 shows highly diagrammatically how the material 31 comprising the residue of ceramization and the ceramic powder fills the pores.

Also advantageously, the pores may be further filled by forming a deposit of ceramic, e.g. of SiC, by chemical vapor infiltration, thus enabling a coating 32 to be obtained that is uniform and continuous and anchored to the composite material (FIG. 3). In addition to reducing surface porosity, such a continuous coating can constitute a reaction barrier capable of preventing any interaction between the metal deposit that is formed subsequently and components of the composite material, in particular its reinforcing fibers when the fibers are carbon fibers.

It should be observed that the method of filling pores by depositing a suspension containing a ceramic powder and a ceramic precursor polymer, transforming the precursor into ceramic, shaving, and then forming a ceramic coating by CVI is described in the patent application in the name of the present Applicant and entitled “A method of surface treatment for a thermostructural composite material part, and its application to brazing thermostructural composite material parts”.

A metal coating is formed on the inside faces of the parts after the surface porosity thereof has been filled as described above, where such filling is performed.

The metal coating serves in particular to provide sealing. Advantageously, it also contributes to bonding between the parts.

In a first implementation of the method, the metal coating comprises a first layer 34 of a metal advantageously having a function of providing a barrier against chemical reaction with an underlying material, and/or of matching thermal expansion, and a second metal layer 35 having the ability to be bonded by hot compression (FIG. 4).

The second layer may be a metal selected from nickel, copper, iron, or an alloy of at least one of them. Nickel (Ni) or a nickel alloy presents the advantages of good thermal conductivity, good capacity for bonding by hot compression, and a high melting temperature avoiding any passage into the liquid state while bonding is being performed by hot compression.

The first layer may be metal selected from rhenium, molybdenum, tungsten, niobium, and tantalum. For a thermostructural composite material having an SiC matrix and carbon fiber reinforcement or SiC fiber reinforcement, and/or when an SiC coating has already been formed, rhenium presents the advantage of not reacting with SiC. It also presents good ductility and has a high melting temperature, thereby avoiding passing into the liquid state during subsequent bonding under hot compression. Rhenium also has a coefficient of expansion that is intermediate between those of SiC and Ni, and thus also constitutes a mechanical matching layer when the second metal layer is constituted at least in part by Ni.

The first and second metal layers are deposited in succession. It is possible to use known deposition methods of the physical vapor deposition type or of the plasma sputtering type.

Prior to bonding the parts together by hot compression, a metal foil 36 (FIG. 5) may be interposed between the facing inside faces of the parts. In the example shown, the metal foil is applied against the inside face of the part 10 that is provided with the leakproofing metal coating. The foil 36 is preferably made of the same material as the sealing second metal layer of the metal coating, e.g. of Ni.

The presence of the foil 36 of thickness lying in the range 0.05 millimeters (mm) to 0.2 mm, for example, guarantees good leakproofing of the inside face 11 of the part 10 when absolute sealing is required. This can be the case when the cooling panel is a combustion chamber wall panel conveying fuel acting as the cooling fluid and the part 10 is the rear portion of the panel, i.e. the portion that is further from the combustion chamber.

The parts are bonded together by hot compression, possibly after the foil 36 has been put into place.

Known methods can be used such as the hot isostatic pressing (HIP) assembly method or the method of pressing the parts together in a hot press.

Bonding by means of hot isostatic pressing is implemented by placing the parts that are to be assembled together against each other in an enclosure while encapsulating the parts in a leakproof cover 37 (FIG. 6). Temperature and pressure are then raised in substantially uniform manner inside the enclosure. Bonding is achieved by metal interdiffusing between the second metal layers of the metal coatings or between the coatings and the metal foil when such a foil has been interposed. The leakproof cover encapsulating the parts is constituted, for example, by a metal foil 37 such as a niobium foil or a foil made of nickel, iron, or an alloy thereof. The cover may be sealed in known manner by welding the foil, and the foil itself may be built up from a plurality of welded-together portions. Tooling elements such as graphite plates 38, 39 may be interposed between the foil 37 and the outside surfaces of the parts 10, 20 so as to avoid the metal foil 37 becoming embedded in said surfaces due to hot isostatic pressing, should the presence of the metal of the foil on said surfaces be undesirable for the resulting cooling panel.

Bonding the parts together by compressing them in a hot press consists in raising the temperature of the parts to be assembled together and in pressing them one against the other by the pressure exerted on their outside faces in a press.

The pressure used for bonding by hot compression lies, for example, in the range 80 megapascals (MPa) to 120 MPa. The temperature is a function of the nature of the metal layer that is used for bonding between the parts. It is well below the melting temperature of the metal of said metal layer, typically lying in the range 60% to 80% of the melting temperature.

When the metal layers in contact are made of nickel, the temperature is selected more particularly to lie in the range 900° C. to 1100° C. both for hot isostatic pressing and for bonding by compressing the parts in a hot press.

FIG. 7 shows the resulting cooling panel 40. It should be observed that the foil 36 is useful for guaranteeing that the inside face of the part 10 is completely leakproof in zones that have not been bonded by hot compression.

Since the metal coatings do not pass into the liquid state while bonding is being performed by hot compression, they retain their continuity, including on the walls of the channels 23.

In a second implementation of the method, the inside faces of the parts 10 and 20 are provided with a metal coating by hot isostatic pressing, possibly after filling in surface pores in the manner described above.

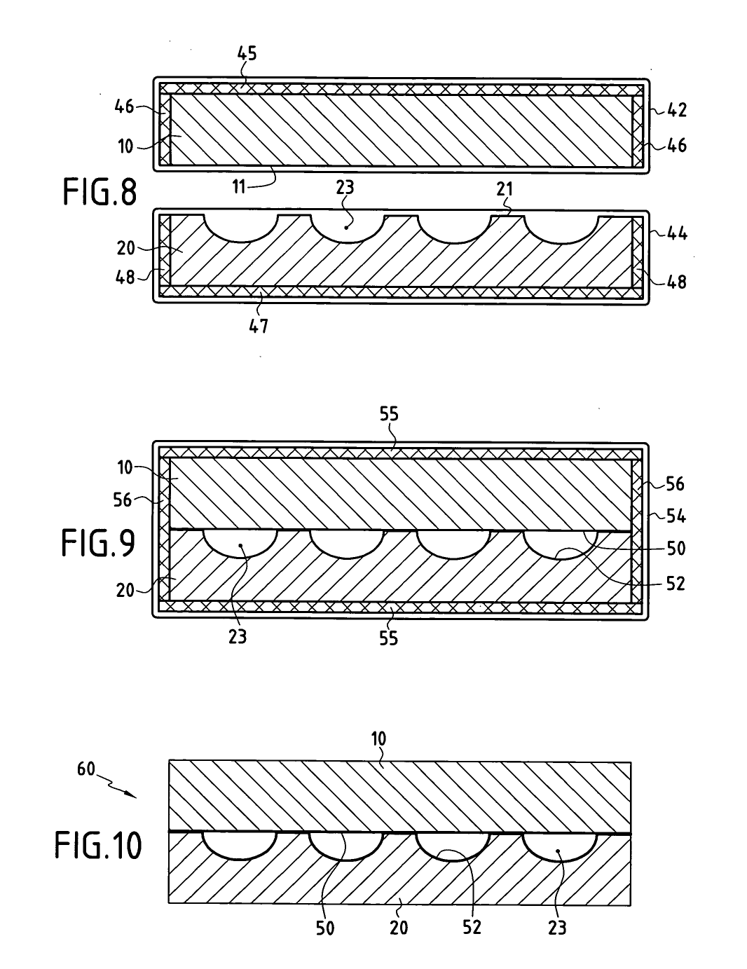

For this purpose, and as shown in FIG. 8, the parts 10 and 20 are encapsulated in respective leakproof metal covers 42, 44 made of the metal that has been selected to form the metal coatings on the inside surfaces 11, 21. A metal is used that is suitable for being formed into foil of quite small thickness, typically lying in the range 0.1 mm to 0.5 mm. The metal must also be suitable for welding, so as to enable the parts to be encapsulated in sealed manner, and it must be ductile so as to lend itself easily to bonding by hot isostatic pressing. Since the cooling panel is normally for use in high temperature applications, it is preferable to select a refractory metal, for example a metal selected from niobium, molybdenum, tungsten, tantalum, and rhenium.

If so desired, in order to restrict the formation of metal coatings to the inside faces 11, 21, the other surfaces on the outsides of the parts 10 and 20 may be provided with tooling elements such as graphite plates 45, 46, 47, and 48 which are interposed between said other surfaces on the outside and the covers 42, 44.

The parts 10, 20 as encapsulated in this way are housed in an enclosure where pressure and temperature are raised progressively so as to bond the inside faces 11, 21 and the facing portions of the metal foil together by hot isostatic pressing. As mentioned above, the pressure used lies in the range 80 MPa to 120 MPa, for example, and the temperature lies in the range 60% to 80% of the melting temperature of the metal of the covers 42, 44, for example.

During hot isostatic pressing, the foil of the cover 44 deforms so as to fit the shape of the channels 23. This leads to the thickness of the foil being reduced in the zones assembled to the walls of the channels 23. In order to avoid this reduction in thickness and the possible appearance of stresses at the corners formed by the rims of the channels 23, it is possible for the portion of the cover 44 that is situated facing the inside face 21 of the part 20 to be constituted by a foil that has been preformed so as to match the indentations of the channels 23.

The parts 10, 20, as provided in this way with metal coatings 50, 52 on their inside faces, are assembled together by having their inside faces bonded together.

Bonding may be performed by hot isostatic pressing. The procedure may be as described above with reference to FIG. 6, with the parts placed one against another being encapsulated in a metal cover 54 (FIG. 9), e.g. a foil made of niobium, or of nickel, iron, or an alloy thereof. Tooling elements, such as graphite plates 55, 56 may be interposed between the outside surfaces of the parts 10, 20 and the cover 54.

A metal foil, e.g. of niobium, may be interposed between the metal coatings 50, 52 as in FIG. 6.

In a variant, bonding may be performed by pressing the parts against each other in a hot press.

The pressure and the temperature used for hot isostatic pressing or for pressing in a hot press can be as defined above.

FIG. 10 shows a resulting cooling panel 60 in which the metal coatings 50, 52 contribute to leakproofing the channels and to bonding the parts together.

### EXAMPLE

Parts 10 and 20 similar to those shown in FIG. 1 were made of C/SiC thermostructural composite material, with the channels and the manifolds being formed by machining.

The porosity of the inside surfaces of the parts was reduced by brushing onto them a composition containing an SiC powder of mean grain size equal to about 9 microns (μm) in a PCS solution in xylene. After drying in air, the PCS was cross-linked at about 350° C. and then transformed into SiC by raising the temperature to about 900° C. A thin coating of SiC having thickness of about 100 μm was then deposited by chemical vapor infiltration, with the coating then being formed over the entire outside surface of each of the parts 10, 20 and not only over the inside faces of the parts. In combination with the residue of ceramizing the PCS associated with the SiC powder, the SiC coating contributes to achieving an effective reduction of porosity.

Metal deposits of rhenium and then of nickel were formed in succession by physical vapor deposition on the inside surfaces of the parts, each of the metal deposits being of a thickness of about 50 μm.

The parts were bonded together by hot isostatic pressing. For this purpose, the parts were placed with their inside faces touching and encapsulated in a niobium foil of thickness equal to 0.5 mm with plates of graphite being interposed between the outside surfaces of the parts and the niobium foil.

Hot isostatic pressing was performed at a pressure of about 90 MPa and at a temperature of about 1000° C.

Tests were performed which demonstrated excellent leakproofing of the channel walls and good quality bonding between the parts, with the breaking strength of the bond being about 70 MPa in shear and about 30 MPa in traction.

1. A method of manufacturing an active cooling panel, the method comprising the steps consisting in providing a first part of thermostructural composite material having an inside face presenting indentations forming channels, forming a metal coating on said face of the first part, providing a second part of thermostructural composite material having an inside face for application on said inside face of the first part, forming a metal coating on said inside face of the second part, and assembling the first and second parts together by bonding said inside faces together, thereby obtaining a cooling panel of thermostructural composite material having integrated fluid flow channels,
wherein the parts are assembled together by bonding said inside faces together by hot compression.

2. A method according to claim 1, wherein the bonding is implemented by hot isostatic pressing.

3. A method according to claim 1, wherein the bonding is implemented by pressing the parts in a hot press.

4. A method according to claim 1, wherein for the bonding by hot compression use is made of at least a portion of the metal coatings formed on said inside faces of the first and second parts.

5. A method according to claim 1, wherein for the bonding by hot compression, a metal foil is interposed between said inside faces of the parts provided with metal coatings.

6. A method according to claim 1, wherein the metal coatings are formed by forming first and second superposed deposits, the first deposit having a function of forming a reaction barrier between the components of the thermostructural composite material and the second deposit, and/or a function of matching thermal expansion, and the second deposit contributing to bonding between the parts by hot compression.

7. A method according to claim 6, wherein the first deposit is selected from rhenium, molybdenum, tungsten, niobium, and tantalum.

8. A method according to claim 6, in which the first and second parts for assembling together are made of composite material including silicon, wherein the first deposit is of rhenium.

9. A method according to claim 4, wherein the metal of the metal layer enabling bonding by hot compression is selected from nickel, copper, iron, and an alloy of at least one or more thereof.

10. A method according to claim 4, wherein the metal enabling bonding by hot compression is selected from nickel and a nickel-based alloy.

11. A method according to claim 1, wherein the metal coating is formed at least in part by physical vapor deposition.

12. A method according to claim 1, wherein the metal coating is formed at least in part by plasma sputtering.

13. A method according to claim 1, wherein said inside faces of the parts are provided with metal coatings by hot isostatic pressing using a metal foil.

14. A method according to claim 13, wherein the first part is assembled with a metal foil that has previously been shaped to match the indentations of the inside face of the first part.

15. A method according to claim 13, wherein the foil forming the metal coating is made of a metal selected from niobium, molybdenum, tungsten, tantalum, and rhenium.

16. A method according to claim 1, wherein, prior to forming the metal coatings on said inside faces of the parts to be assembled together, treatment is performed to reduce the surface porosity of the thermostructural composite material on at least one of said inside faces.

17. A method according to claim 16, wherein said porosity-reducing treatment comprises: applying a suspension to at least one of said inside faces of the parts, the suspension comprising a ceramic powder and a ceramic material precursor in solution, and transforming the precursor into ceramic material.

18. A method according to claim 17, wherein the ceramic material precursor is a polymer which is cross-linked and transformed into ceramic by heat treatment.

19. A method according to claim 17, wherein, after transforming the precursor into ceramic material and prior to forming the metal coating, a ceramic deposit is made by chemical vapor infiltration or deposition on said inside faces of the parts to be assembled together.

20. A method according to claim 1, wherein the parts to be assembled together are made of ceramic matrix composite material.

21. A method according to claim 20, wherein the parts to be assembled together are made of ceramic matrix material in which the matrix is constituted at least in part by silicon carbide.
